(19) United States
(12) Patent Application Publication
(10) Pub. No.: US 2018/0224691 A1
(43) Pub. Date: Aug. 9, 2018

(54) DISPLAY PANEL, METHOD FOR FABRICATING THE SAME, DISPLAY DEVICE

(71) Applicants: BOE Technology Group Co., Ltd., Beijing (CN); BEIJING BOE OPTOELECTRONICS TECHNOLOGY CO., LTD., Beijing (CN)

(72) Inventors: Xiaojuan WU, Beijing (CN); Kaixuan Wang, Beijing (CN)

(21) Appl. No.: 15/569,373

(22) PCT Filed: May 3, 2017
(86) PCT No.: PCT/CN2017/082876

§ 371 Date: Oct. 25, 2017

(30) Foreign Application Priority Data
May 25, 2016 (CN) 201610353714.X

(51) Int. Cl. G02F 1/1333; B32B 7/12; B32B 7/04; B32B 37/18; B32B 37/12; B32B 37/00; G02F 1/1339; C09J 9/00; C09J 11/04

(52) U.S. Cl. CPC G02F 1/133382; G02F 1/1368; B32B 7/045; B32B 37/18; B32B 37/1284; B32B 37/0076; G02F 1/1339; C09J 9/00; C09J 11/04; B32B 2250/02; B32B 2255/00; B32B 2307/402; B32B 2307/302; B32B 2457/202; G02F 2001/13398; B32B 7/12

(57) ABSTRACT

A display panel, a method for fabricating the same, and a display device are disclosed. The display panel comprises a first and second base plate which are assembled by a frame sealant. The frame sealant comprises a frame sealant matrix and a heat conductive material. The display panel avoids excessively high temperature at the local position, and ensures that the whole screen region has a uniform temperature distribution, thus preventing abnormal operation of the display device.

### RELATED APPLICATIONS

The present application claims the benefit of Chinese Patent Application No. 201610353714.X, filed on May 25, 2016, the entire disclosure of which is incorporated herein by reference.

### TECHNICAL FIELD

The present disclosure relates to the field of display technology, and particularly to a display panel, a method for fabricating the same, and a display device.

### BACKGROUND

With the rapid development of mobile phone industry, the users raise increasing requirements for the appearance, performance, display quality of mobile phones, and thus raise increasing requirements for a liquid crystal display device. The resolution of the liquid crystal display device is increasing. Display devices of a Full High Definition (FHD), Quarter High Definition (QHD), and 4K2K have been developed and put into applications.

The liquid crystal display device with an increasing resolution poses increasing requirements for the integrated circuit (IC). The IC tends to generate heat during operation, so that temperature at a local position near the IC of the liquid crystal display device increases significantly. When the temperature is close to or exceeds a clearing point of liquid crystal, dielectric anisotropy of liquid crystal gradually disappears, and liquid crystal may not react to the electric field. As for a Fringe Field Switching (FFS) display device, the display device in an on-state suffers from a defect of becoming dark. This is especially the case when negative liquid crystal is now generally adopted to improve transmittance of the liquid crystal display device. In case negative liquid crystal is adopted, liquid crystal generally has a low clearing point in order to improve response rate and reduce voltage Vop. When a negative liquid crystal display device with a high resolution is energized for a long time or stays in the reliability test, the liquid crystal display device is more prone to the defect of becoming dark due to excessively high temperature at the local position.

### SUMMARY

Embodiments of the present disclosure provide a display panel, which comprises a first and second base plate, wherein the first and second base plate are assembled by a frame sealant, and the frame sealant comprises a frame sealant matrix and a heat conductive material.

In this embodiment, the first and second base plate of the display panel are assembled by the frame sealant which comprises the frame sealant matrix and the heat conductive material. Thus, when the display panel is subject to a temperature rise in a local position, the heat conductive material in the frame sealant can rapidly conduct the excessive heat in the local position to the whole display panel, so that an overall temperature of the display panel tends to become uniform, thus preventing abnormal operation of the display device.

For example, the heat conductive material comprises graphene.

In this embodiment, graphene has excellent heat conduction performance, with a heat conductivity coefficient up to 5300 W/m·K. Thus, graphene is capable of rapidly and efficiently conducting excessive heat at the local position of the display panel to the whole screen of the display panel. This prevents the display device from abnormal operation due to excessively high temperature at the local position.

For example, the weight percentage of graphene in the frame sealant is about 0.3-3%.

Embodiments of the present disclosure provide a display device comprising the display panel as described above.

Embodiments of the present disclosure provide a method for fabricating a display panel, comprising:

preparing a first and second base plate;

preparing a frame sealant which comprises a frame sealant matrix and a heat conductive material; and

applying the frame sealant on a peripheral region of the first base plate, and assembling the first base plate on which the frame sealant has been applied to the second base plate to form a display panel.

For example, the heat conductive material comprises graphene.

For example, the step of preparing the frame sealant comprising the frame sealant matrix and the heat conductive material comprises: mixing the frame sealant matrix and graphene at a preset weight percentage uniformly to form a mixture; and placing the mixture in a debubbler, and debubbling in a dark (i.e., no light) environment for a preset duration to form the frame sealant.

For example, the weight percentage of graphene in the frame sealant is about 0.3-3%.

For example, the preset duration is about 1-5 hours.

### BRIEF DESCRIPTION OF THE DRAWINGS

In order to explain the technical solutions in the embodiments of the present disclosure or the prior art more clearly, the drawings to be used in the description of the embodiments or the prior art will be introduced briefly in the following, apparently, the drawings described below are only some embodiments of the present disclosure, the ordinary skilled person in the art, on the premise of not paying any creative work, can also obtain other drawings from these drawings.

FIG. 1 is a structural view for illustrating a display panel in an embodiment of the present disclosure;

FIG. 2 is a plan view for illustrating a display device in an embodiment of the present disclosure; and

FIG. 3 is a flow chart for illustrating a method for fabricating a display panel in an embodiment of the present disclosure.

### DETAILED DESCRIPTION OF EMBODIMENTS

The inventors has recognized that when an existing display device is energized for a long time or stays in the reliability test, excessively high temperature may occur at a local position. As a result, the whole screen of the display device has a non-uniform distribution of temperature, which may lead to abnormal operation of the display device.

Embodiments of the present disclosure provide a display panel, a method for fabricating the same, and a display device, which avoid excessively high temperature at the local position of the display panel, ensure that the whole screen of display panel has a uniform temperature distribution, and prevent abnormal operation of the display device.

In order to explain the technical solutions in the embodiments of the present disclosure or the prior art more clearly, the drawings to be used in the description of the embodiments or the prior art will be introduced briefly in the following, apparently, the drawings described below are only some embodiments of the present disclosure, the ordinary skilled person in the art, on the premise of not paying any creative work, can also obtain other drawings from these drawings.

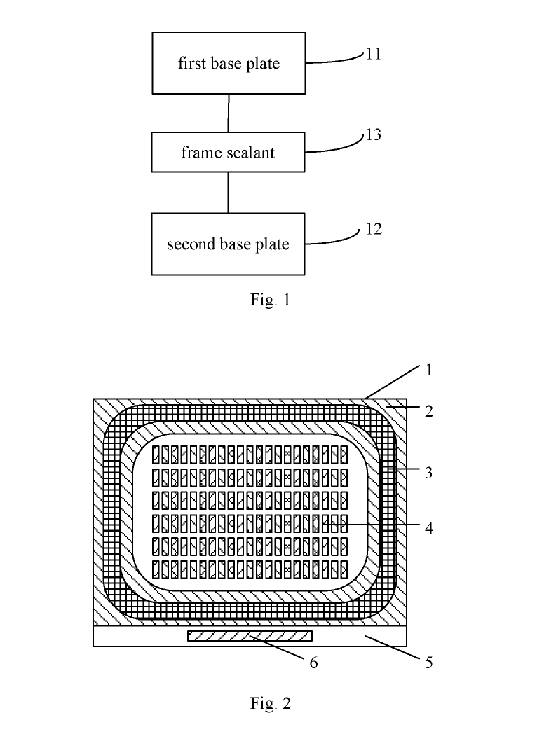

FIG. 1 is a structural view of a display panel in an embodiment of the present disclosure. The display panel comprises a first base plate 11 and a second base plate 12. The first base plate 11 and the second base plate 12 are assembled by means of a frame sealant 13. The frame sealant 13 comprises a frame sealant matrix and a heat conductive material.

The heat conductive material in the frame sealant 13 comprises, e.g., graphene.

Namely, the heat conductive material for example only comprises graphene, or comprises graphene and other heat conductive material(s).

For example, when the heat conductive material only comprises graphene, the weight percentage of graphene in the frame sealant 13 is about 0.3-3%. In an example, the weight percentage of graphene in the frame sealant 13 is 0.3%. In an example, the weight percentage of graphene in the frame sealant 13 is 2%. In an example, the weight percentage of graphene in the frame sealant 13 is 3%.

Embodiments of the present disclosure further provide a display device. The display device comprises the display panel as described above, which is assembled by the frame sealant comprising the frame sealant matrix and the heat conductive material. The heat conductive material for example comprises graphene or the like.

Graphene is a new generation of transparent heat conductive material, and has a perfect two-dimensional crystalline structure. The crystalline lattice of graphene is a hexagon which is enclosed by six carbon atoms and has a thickness of one atomic layer. Graphene is known as the thinnest and hardest material, which has a heat conductivity coefficient up to 5300 W/m·K and has excellent heat conductivity.

Each display panel comprises an IC unit. The IC unit in the display panel generates heat during operation. Especially when the display device is energized for a long time or stays in the reliability test, the IC unit will generate lot of heat. When the heat is transferred to the frame sealant, due to graphene of high heat conductivity comprised in the frame sealant comprises, excessive heat at a local position can be rapidly conducted through the frame sealant to the whole display panel and uniformly distributed. This results in small variation in temperature of the whole display panel, thus avoiding abnormal operation of the display device.

A specific embodiment is described as below.

As shown in FIG. 2, a plan view for a display device an embodiment of the present disclosure is shown. The display device is a liquid crystal display device, and the liquid crystal display device comprises a liquid crystal display panel.

In the embodiment shown in FIG. 2, the liquid crystal display device comprises a color film substrate 1, a black matrix (BM) 2 on the color film substrate, a frame sealant 3, a Thin Film Transistor (TFT) base plate (also referred to as an array substrate) 5, and an IC unit 6 on the TFT substrate 5. The IC unit 6 is located at an outer side of a display region 4 of the liquid crystal display device. The color film substrate 1 and the TFT substrate 5 are assembled by means of the frame sealant 3. The frame sealant 3 comprises a frame sealant matrix and graphene.

Of course, apart from the unit structures shown in FIG. 2, the display device further comprises other unit structures, e.g., a liquid crystal layer between the color film substrate 1 and The TFT substrate 5. These unit structures are well known for the person with ordinary skill in the art, and thus the description thereof are omitted herein.

As for a conventional liquid crystal display device, when it is energized for a long time or stays in the reliability test, the IC unit may generate heat and the temperature at the local position near the IC unit increases significantly. The local heat gradually approaches the liquid crystal display region from the position near the IC unit through the frame sealant, so that liquid crystal in the liquid crystal display region is subject to a rise in temperature. When this temperature is close to or exceeds the liquid crystal clearing point, the dielectric anisotropy of liquid crystal becomes weak or disappears. Liquid crystal weakly reacts to the electric field, so that a defect of becoming dark occurs in the liquid crystal display device.

In an embodiment of the present disclosure, the frame sealant 3 comprises graphene. When the liquid crystal display device is energized for a long time or stays in the reliability test, the IC unit 6 may generate heat. The temperature at a local position near the IC unit 6 increases significantly, and this portion of heat firstly contacts the frame sealant 3 near the IC unit. Since the frame sealant 3 comprises graphene of high heat conduction performance, heat can be rapidly and uniformly distributed in the whole screen through the frame sealant 3. In this way, the whole screen is subject to a very small temperature fluctuation, and the liquid crystal will not be affected by temperature and can react normally to the electric field. Namely, the liquid crystal display device can display normally. As can be seen, in the liquid crystal display device of embodiments of the present disclosure, the defect of becoming dark occurs in the liquid crystal display device can be prevented.

It is noted that the liquid crystal display panel in embodiments of the present disclosure is not limited to the structure shown in FIG. 2, and the display panel in embodiments of the present disclosure is not limited to the liquid crystal display panel. Any display panel in which the first and second base plate are assembled by a frame sealant comprising a frame sealant matrix and a heat conductive material (e.g., graphene) falls within the protection scope of the present disclosure.

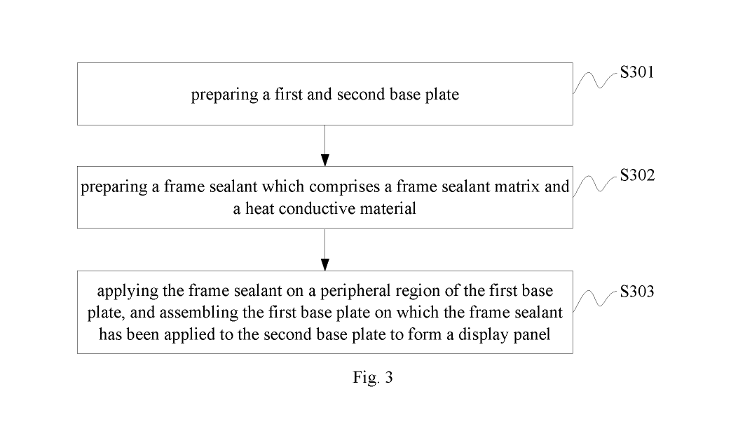

As shown in FIG. 3, in an embodiment of the present disclosure, a method for fabricating a display panel comprises:

S301, preparing a first and second base plate;

S302, preparing a frame sealant which comprises a frame sealant matrix and a heat conductive material; and

S303, applying the frame sealant on a peripheral region of the first base plate, and assembling the first base plate on which the frame sealant has been applied to the second base plate to form a display panel.

It is noted that the terms “first base plate” and “second base plate” as used herein indicate two opposing base plates of the display panel, and generally can be used interchangeably. Thus, the expression for step S302 is equivalent to “applying the frame sealant comprising the frame sealant matrix and the heat conductive material on a peripheral region of the second base plate, and assembling the second base plate on which the frame sealant has been applied to the first base plate to form the display panel.

For example, the heat conductive material comprises graphene.

For example, the step of preparing the frame sealant comprising the frame sealant matrix and the heat conductive material comprises: mixing the frame sealant matrix and graphene at a preset weight percentage uniformly to form a mixture; and placing the mixture in a debubbler, and debubbling in a dark environment for a preset duration to form the frame sealant.

For example, the weight percentage of graphene in the frame sealant comprising the frame sealant matrix and graphene is about 0.3-3%.

For example, the preset duration is about 1-5 hours. For example, the preset duration is 1 hour, 2.5 hours, 5 hours, or the like.

A specific embodiment for the method for fabricating a display panel is described as below.

In an embodiment, the method for fabricating a display panel comprises the following step s:

step A: preparing a first and second base plate;

step B: mixing the frame sealant matrix and graphene uniformly at a weight percentage of 99:1 to form a mixture (i.e., the weight percentage of graphene in the mixture is 1%);

step C: placing the mixture from step B into a debubbler, and debubbling in a dark environment for 2 hours to form the frame sealant; and

step D: applying the frame sealant (comprising the frame sealant matrix and graphene) from step C on a peripheral region of the first base plate, and assembling the first base plate on which the frame sealant comprising the frame sealant matrix and graphene has been applied to the second base plate to form the display panel.

Similarly, the above expression for step D is equivalent to “applying the frame sealant comprising the frame sealant matrix and graphene from step C on the peripheral region of the second base plate, and assembling the second base plate on which the frame sealant comprising the frame sealant matrix and graphene has been applied to the first base plate to form the display panel”.

In another embodiment, a method for fabricating a display panel comprises the following step s:

step a: preparing a first and second base plate;

step b: mixing the frame sealant matrix and graphene uniformly at a weight percentage of 99.5:0.5 to form a mixture (i.e., the weight percentage of graphene in the mixture is 0.5%);

step c: placing the mixture from step b into a debubbler, and debubbling in a dark environment for 2.5 hours to form the frame sealant; and

step d: applying the frame sealant (comprising the frame sealant matrix and graphene) from step c on a peripheral region of the first base plate, and assembling the first base plate on which the frame sealant comprising the frame sealant matrix and graphene has been applied to the second base plate to form the display panel.

Similarly, the above expression for step d is equivalent to “applying the frame sealant comprising the frame sealant matrix and graphene from step c on the peripheral region of the second base plate, and assembling the second base plate on which the frame sealant comprising the frame sealant matrix and graphene has been applied to the first base plate to form the display panel”.

In another embodiment, in case the display panel is a liquid crystal display panel, as an implementation, a method for fabricating the display panel for example comprises:

step (1): preparing a color film substrate and a TFT substrate;

step (2): mixing the frame sealant matrix and graphene uniformly at a weight percentage of 97:3 to form a mixture (i.e., the weight percentage of graphene in the mixture is 3%);

step (3): placing the mixture from step (2) into a debubbler, and debubbling in a dark environment for 1 hour to form the frame sealant; and

step (4): applying the frame sealant (comprising the frame sealant matrix and graphene) from step (3) on a peripheral region of the color film substrate, assembling the color film substrate on which the frame sealant comprising the frame sealant matrix and graphene has been applied to the TFT substrate on which liquid crystal has been dropped, and performing UV polymerization and thermal polymerization to form the liquid crystal display panel.

Similarly, the above expression for step (4) is equivalent to “applying the frame sealant comprising the frame sealant matrix and graphene from step (3) on the peripheral region of the TFT substrate, assembling the TFT substrate on which the frame sealant comprising the frame sealant matrix and graphene has been applied to the color film substrate on which liquid crystal has been dropped, and performing UV polymerization and thermal polymerization to form the liquid crystal display panel”.

To sum up, embodiments of the present disclosure provide a display panel, wherein a first and second base plate are assemble by a frame sealant which comprises a frame sealant matrix and a heat conductive material. When the display panel is subject to a temperature rise in a local position, the heat conductive material in the frame sealant can rapidly conduct the excessive heat in the local position to the whole display panel, so that an overall temperature of the display panel tends to become uniform, thus preventing abnormal operation of the display device.

Apparently, the person with ordinary skill in the art can make various modifications and variations to the present disclosure without departing from the spirit and the scope of the present disclosure. In this way, provided that these modifications and variations of the present disclosure belong to the scopes of the claims of the present disclosure and the equivalent technologies thereof, the present disclosure also intends to encompass these modifications and variations.

1. A display panel, comprising a first and second base plate, wherein the first and second base plate are assembled by a frame sealant, and the frame sealant comprises a frame sealant matrix and a heat conductive material.

2. The display panel of claim 1, wherein the heat conductive material comprises graphene.

3. The display panel of claim 2, wherein the weight percentage of graphene in the frame sealant is about 0.3-3%.

4. The display panel of claim 2, wherein the weight percentage of graphene in the frame sealant is 1% or 2%.

5. The display panel of claim 1, wherein the first base plate is one of a color film substrate and a TFT substrate, and the second base plate is the other of the color film substrate and the TFT substrate

6. A display device, comprising a display panel which comprises a first and second base plate, wherein the first and second base plate are assembled by a frame sealant, and the frame sealant comprises a frame sealant matrix and a heat conductive material.

7. A method for fabricating a display panel, comprising steps of:
preparing a first and second base plate;
preparing a frame sealant which comprises a frame sealant matrix and a heat conductive material; and
applying the frame sealant on a peripheral region of the first base plate, and assembling the first base plate on which the frame sealant has been applied to the second base plate to forma display panel.

8. The method of claim 7, wherein the heat conductive material comprises graphene.

9. The method of claim 8, wherein the step of preparing the frame sealant comprising the frame sealant matrix and the heat conductive material comprises:
mixing the frame sealant matrix and graphene at a preset weight percentage uniformly to forma mixture; and
placing the mixture in a debubbler, and debubbling in a dark environment for a preset duration to form the frame sealant.

10. The method of claim 9, wherein the weight percentage of graphene in the frame sealant is about 0.3-3%.

11. The method of claim 9, wherein the weight percentage of graphene in the frame sealant is 1% or 2%.

12. The method of claim 9, wherein the preset duration is about 1-5 hours.

13. The method of claim 9, wherein the preset duration is 1 hour.

14. The method of claim 9, wherein the preset duration is 2.5 hours.

15. The method of claim 7, wherein the first base plate is one of a color film substrate and a TFT substrate, and the second base plate is the other of the color film substrate and the TFT substrate.

16. The display device of claim 6, wherein the heat conductive material comprises graphene.

17. The display device of claim 16, wherein the weight percentage of graphene in the frame sealant is about 0.3-3%.

18. The display device of claim 16, wherein the weight percentage of graphene in the frame sealant is 1% or 2%.

19. The display device of claim 6, wherein the first base plate is one of a color film substrate and a TFT substrate, and the second base plate is the other of the color film substrate and the TFT substrate.
